(19) United States
(12) Patent Application Publication
(10) Pub. No.: US 2011/0116935 A1
(43) Pub. Date: May 19, 2011

(54) METHOD OF MANUFACTURING A TURBINE BLADE HALF, A TURBINE BLADE HALF, A METHOD OF MANUFACTURING A TURBINE BLADE, AND A TURBINE BLADE

(75) Inventor: Gerrit Jan Wansink, Neede (NL)

(73) Assignee: XEMC Darwind B.V., Hilversum (NL)

(21) Appl. No.: 12/992,644

(22) PCT Filed: May 14, 2009
(86) PCT No.: PCT/NL2009/000114

§ 371 Date: Jan. 6, 2011

(30) Foreign Application Priority Data
May 16, 2008 (NL) 1035427
Aug. 25, 2008 (NL) 1035861

(51) Int. Cl. F01D 5/14; B29C 70/34

(52) U.S. Cl. 416/229 R; 156/245

(57) ABSTRACT

An aspect of the invention relates to a method of producing a turbine blade half using resin infusion molding. The method includes providing a mold for a turbine blade shell with fiber mats, placing a strengthening member over the fiber mats in the mould; placing a air-impermeable sealing layer over the fiber mats and against the strengthening member; introducing a curable resin in the fiber mats under reduced pressure, including in the area below the strengthening member; and curing the resin to form a turbine blade half, said turbine blade half comprising a turbine blade shell attached to the strengthening member. An aspect of the invention also relates to a turbine blade half, a method of producing a turbine blade, and to a turbine blade.

### CROSS-REFERENCE TO RELATED APPLICATION

This application is a Section 371 National Stage Application of International Application PCT/NL2009/000114 filed May 14, 2009 and published as WO 2009/139619 in English.

### BACKGROUND

The discussion below is merely provided for general background information and is not intended to be used as an aid in determining the scope of the claimed subject matter.

Aspects of the present invention relate to a method of manufacturing a turbine blade half by resin infusion molding.

In recent years the development of mass-produced wind turbines has moved towards making them larger and larger, both in output and in size. This process calls for better and more cost-efficient components and manufacturing methods, and which particular holds true for wind turbine blades, the manufacture of which is time-consuming. Wind turbine blades known in the art are typically made of fiberglass reinforced by metal, wood or carbon fibers. The blades are typically manufactured by molding and curing two blade halves in two independent molds. Subsequently, the surface areas of the blade halves to be connected are provided with an adhesive (epoxy-resin) and the halves are placed on top of each other and connected to each other, for example using the method of EP1695813. Typically a wind turbine blade contains a strengthening member, such as a spar. Such strengthening members both increase the strength and help maintain a proper aerodynamic shape of the wind turbine blade.

A problem with the manufacture of turbine blades is that it is time-consuming and costly. For example, the molds for a pair of wind turbine blade halves with a length of 55 m may cost C=1 M. This contributes significantly to the cost if production of a turbine blade is slow.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

An aspect of the invention provides a method of producing a turbine blade half using resin infusion molding, said method comprising
providing a mold for a turbine blade shell with fiber mats,
placing a strengthening member over the fiber mats in the mold;
placing an air-impermeable sealing layer over the fiber mats and against the strengthening member;
introducing a curable resin in the fiber mats under reduced pressure, including in the area below the strengthening member; and
curing the resin to form a turbine blade half, said turbine blade half comprising a turbine blade shell attached to the strengthening member.

Thus this aspect of the present invention integrates the step of curing the turbine blade shell and the step of attaching the strengthening member to the turbine blade shell in a single step. In the present application, the term “turbine blade”, or blade for short, includes a section of a turbine blade, such as of a stall-controlled turbine blade. The resin used for the method is conveniently a resin conventionally used for the manufacture of wind turbine blades using Resin Injection Molding (RIM). A typical resin for RIM is epoxy resin that is cured using heat, for example at 75° C. Similarly, the fiber mats are preferably glass-fiber mats. If one were to wrap a rope around the cured resin connecting the strengthening element to the turbine blade shell, in general at least 40%, preferably at least 60% and more preferably at least 80% of the surface area enclosed by the rope is cured resin not comprising foam. In general, while under reduced pressure, the part of the strengthening member closest to the fiber mats will be at a distance of less then 3 mm, such as about 2 mm from the fiber mats. Preferably the term “over” means “on top of”

According to a preferred embodiment, the strengthening member is a fiber-reinforced member comprising cured resin.

This results in a turbine blade half that is light and also is built up of components that behave thermally similar to a large extent (expansion/shrinking due to temperature). The resin is preferably of the same type, i.e. involving the same type of chemical groups involved in the curing reaction. This increases the bonding of the shell to the strengthening member. Conveniently, the cured resin is the same as used for the turbine blade half.

According to a preferred embodiment, the fiber-reinforced member comprises a base, the fiber-reinforced member being cured resin while a surface-area increasing liner was present against the base, and the method comprising the step of removing the liner before placing the strengthening member over the fiber mats in the mold.

According to a preferred embodiment, the strengthening member comprises an elongated base, a longitudinal wall extending from said base, and a flange extending from said wall at an edge of said wall opposite to where the wall extends from the base.

Such a flange may, and will, be used to join it to a corresponding flange of a second turbine blade half to form a turbine blade. It increases the surface area over which the strengthening members of both halves are joined, and thus the strength. A flange substantially parallel to the base facilitates the application of curable resin.

More preferably, a strengthening member is used having
an elongated base,
two longitudinal walls extending from said elongated base at opposite edges of said elongated base,
wherein each longitudinal wall has a flange extending from a respective wall, the flanges extending away from each other.

Thus a very simple yet strong and stiff turbine blade half can be provided.

According to a preferred embodiment, the turbine blade shell has a leading edge and a trailing edge, and the flanges have a flange area facing away from the base, said flange areas being in a plane defined by the leading edge and the trailing edge.

The flanges will be connected to opposite flanges of another turbine blade half. This allows for the manufacture of a turbine blade having increased strength, because during use subjected to wind, the shear load at the joint is at a minimum.

According to a preferred embodiment, the strengthening member is attached to the sealing film with double-sided sealant layer.

This is a very convenient way to achieve a satisfactory seal to perform the introduction of resin under reduced pressure, which pressure is typically in the order of 2% of atmospheric pressure. To work in the most practical way, it is the strengthening member that is provided with double-sided sealant layer, so the person manufacturing the turbine blade half only has to handle with the sealing film. A sealant layer is a special type of double-sided adhesive tape that is not porous and for that reason capable of maintaining the vacuum.

An aspect of the invention relates to a turbine blade half as can be manufactured using the method.

An aspect of the present invention also relates to a method of manufacturing a wind turbine blade, wherein a turbine blade half
is obtained by
   providing a mold for a turbine blade shell with fiber mats,
   placing a strengthening member comprising a base, a wall extending from said base, and a flange extending from said wall at an edge of said wall opposite to where the wall extends from said base over the fiber mats in the mold;
   placing an air-impermeable sealing film over the fiber mats and against the strengthening member;
   introducing a curable resin in the fiber mats under reduced pressure, including in the area below the strengthening member; and
   curing the resin to form a turbine blade half, said turbine blade half comprising a turbine blade shell attached to the strengthening member by the cured resin
and having a leading edge and a trailing edge is connected to a second turbine blade half such that the leading edges of both halves and the trailing edges of said halves are connected and the flange of the strengthening member of the first turbine blade half is connected to the second turbine blade half.

The periphery of the second turbine blade half is, at least as far as the leading edge and trailing edge are concerned, a mirror image of the first turbine blade half, i.e. it is congruent (of the same size and shape). The second turbine blade half is preferably also manufactured using the method of producing a turbine blade half according to the invention.

According to an important embodiment, each turbine blade half comprises a strengthening member having a flange, and the flanges of opposite turbine blade halves are connected.

This results in a very strong wind turbine blade.

Generally, the halves are connected using a curable resin.

This curable resin is preferably the same as used to manufacture the turbine blade halves, except that it will contain a filler to increase its viscosity. In addition or alternatively, it may have a higher molecular weight.

All preferred embodiments discussed for the method of manufacturing a turbine blade half are equally applicable to the method of manufacturing the turbine blade and the covered by the present application, but not further repeated for the sake of conciseness only.

Finally, an aspect of the present invention relates to a turbine blade as can be manufactured using the method according to the invention.

### BRIEF DESCRIPTION OF THE DRAWINGS

Aspects of the present invention will now be illustrated with reference to the accompanying drawing, where

FIG. 1a-d shows, in cross-sectional views, steps in the manufacture of a turbine blade half;

FIG. 2 shows a top view of the blade of FIG. 1; and

FIG. 3 shows a step in the manufacture of a turbine blade.

### DETAILED DESCRIPTION OF THE ILLUSTRATIVE EMBODIMENTS

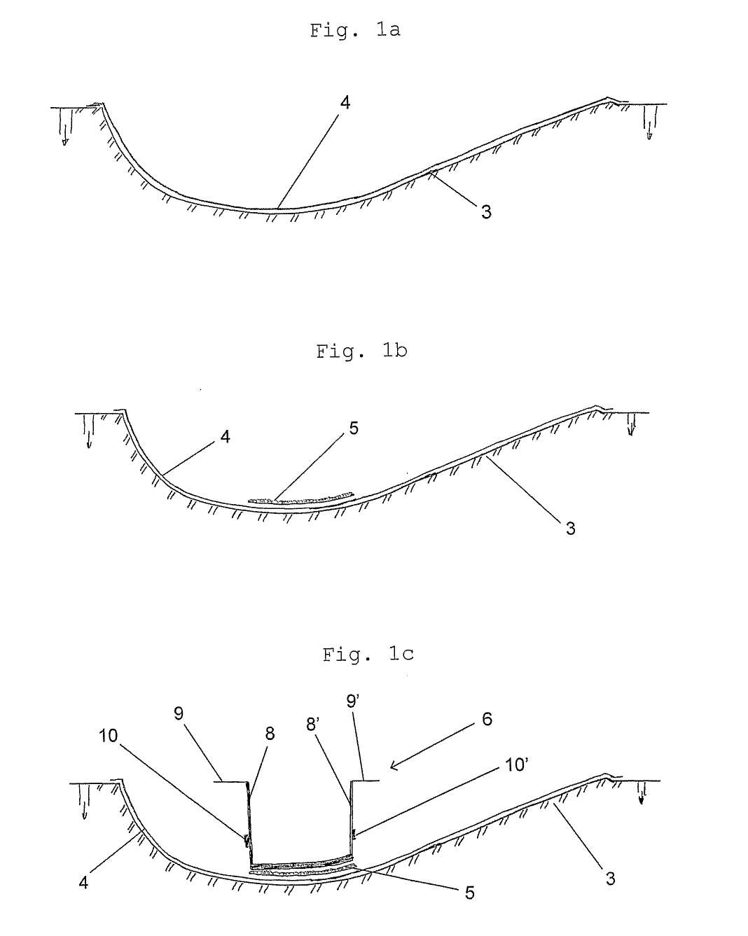

Now reference is made to FIG. 1a-d to detail the method of manufacturing a wind turbine blade half 1 of fiberglass reinforced epoxy. The technique of producing turbine blade halves 1, 2 of fiberglass reinforced epoxy is very well known in the art, for which reason the description will focus on the way in which the method according to the present invention differs from the known method.

FIG. 1a shows a mold 3 for a wind turbine blade shell 1. The mold 3 is provided with fiberglass mats 4. Other types of mats may also be used, such as mats made of super fibers. On top of the fiberglass mats a further mat 5 (FIG. 1b), also known as an infusion mesh having a more open structure than the fiberglass mats 4. This further mat 5 may or may not be made of a reinforcing material such as fiberglass, carbon fiber, Dyneema™ etc.

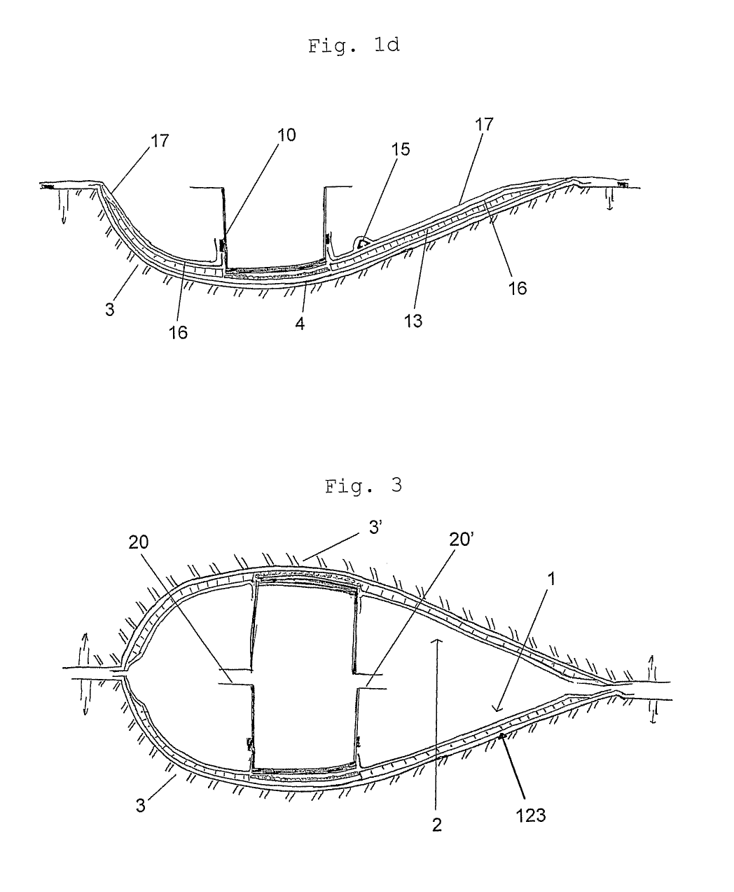

A U-shaped beam 6 having an elongated base 7 (FIG. 2), two side walls 8, 8′ extending over the length of the base 7, and flanges 9, 9′, is placed on top of the further mat 5. The further mat 5 will help to ensure that epoxy resin will reach every part of the fiberglass mats 4, even if it is below the U-shaped beam 6. The U-shaped beam 6 is a strengthening member, and will provide enhanced structural strength to the finished turbine blade 123 and will help to maintain its aerodynamic shape. The U-shaped beam 6 is made of fiberglass mats and epoxy resin, as is known in the art. The epoxy resin may have been cured in contact with a textured peel ply, such as a monofilament nylon peel ply being present at the side of the base opposite to the sidewalls. This peel ply (not shown) is removed before the U-shaped beam 6 is placed on top of the further mat 5, providing a rough surface of increase surface area to increase the bond strength between the U-shaped beam 6 and the epoxy resin later in the process. By removing the peel ply right before placing the U-shaped beam 6 on top of the further mat 5, the rough surface area is also free of contaminants (such as dust, grease etc.).

The U-shaped beam 6 is provided with double-sided sealant layers 10, 10′ before it is placed on top of the further mat 5. The sealant layers 10, 10′ are suitably non-vulcanized butyl rubber. It is sold as a layer of non-vulcanized butyl rubber between two release liners.

In general, the shell 11 of a turbine blade half 1 is a composite material, usually a sandwich of a layer of fiber mat-reinforced cured resin 12, a foam layer 13 and another layer of fiber mat-reinforced cured resin 14. However, for the strongest wind turbine blades 123, it is essential that the strengthening member 6 is in a direct and ample connection with the resin infused in the fiber mats 4 closest to the mold 3 over a large effective cross-sectional area of resin (cross-sectional area parallel to the shell 11). In general, it is not desirable to have the foam layer 13 extending below the strengthening element. If sufficient surface area below the base 7 is cured resin, this could be acceptable but still it is not recommended.

To facilitate evacuation of air and the introduction of epoxy resin, an Ω-profile 15 is placed with its open side onto the fiberglass mats (FIG. 1c), said Ω-profile 15 acting as a channel for transport and distribution of curable resin. If a foam layer 13 is used, it contains through-holes (not shown) to allow curable resin to pass to the fiber mats 4 closest to the mold 3. The foam 13 itself will be a non-porous foam, however, to achieve optimum strength.

Subsequently the fiberglass mats 4—or the sandwich of fiberglass mats 4, the foam layer 13 and another layer of fiberglass mats 16—and the Ω-profile are covered with a disposable plastic film 17. The plastic film 17 is sealed against the U-shaped beam 6 using the double-sided sealant layers 10, 10′. Using a vacuum pump (not shown) air is removed (arrows) from under the plastic film 17 and curable epoxy resin is introduced while vacuum is maintained. The epoxy resin penetrates all the voids below the plastic film 17, entering the fiberglass mats 4 and the further mat 5. Subsequently the epoxy resin is cured at an elevated temperature (e.g. 75° C.). This not only results in the turbine blade shell 11 being cured, but also the turbine blade shell 11 being bonded to the U-shaped beam 6 at the same time. This saves valuable time, because no longer it is required to cool the shell, apply epoxy resin and a U-shaped beam, and heat the assembly to cure the epoxy resin.

After curing the curable resin, by heating the mold 3, the plastic film 17 and the Ω-profile 15 are removed.

FIG. 2 shows a top view of a turbine blade half 1, with the U-shaped beam 6 extending over a major part of the length of the turbine blade half 1.

Producing a turbine blade 123 may simply be achieved by manufacturing two turbine blade halves 1, 2 using the method according to the invention described above, applying filler-containing epoxy resin at the surfaces of the turbine blade halves 1 that will be in contact, in particular the flanges 9, 9′ of the U-shaped beam 6, the leading edge 18 and the trailing edge 19 of at least one of the two turbine blade halves 1, 2, followed by placing the turbine blade halves 1, 2 against each other and curing the epoxy resin. By heating the molds 3, 3′ the epoxy resin is cured.

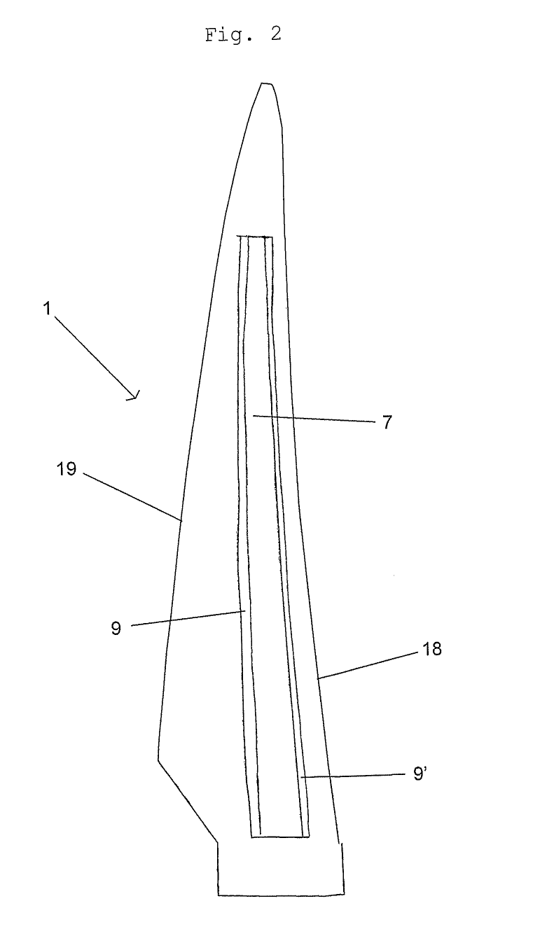

As can be seen in FIG. 3, the flanges 9, 9′ have surfaces in a plane defined by the leading and trailing edges 18, 19. The flanges 9, 9′ themselves provide for a larger surface area (bonding areas 20, 20′) to bond the turbine blade halves 1, 2 together. The bond itself is at a location in the turbine blade 123 where forces are on average smaller than elsewhere in the U-shaped beam 6, resulting in a stronger wind turbine blade 123.

1. A method of producing a turbine blade half by resin infusion molding, said method comprising:
providing a mold for a turbine blade shell with fiber mats,
placing a strengthening member over the fiber mats in the mold;
placing an air-impermeable sealing film over the fiber mats and against the strengthening member;
introducing a curable resin in the fiber mats under reduced pressure, including in the area below the strengthening member; and
curing the resin to form a turbine blade half, said turbine blade half comprising a turbine blade shell attached to the strengthening member by the cured resin.

2. The method according to claim 1, wherein the strengthening member is a fiber-reinforced member comprising cured resin.

3. The method according to claim 1, wherein the fiber-reinforced member comprises a base, the fiber-reinforced member being cured resin while a surface-area increasing liner was present against the base, and the method comprising removing the liner before placing the strengthening member over the fiber mats in the mold.

4. The method according to claim 1, wherein the strengthening member comprises an elongated base, a longitudinal wall extending from said base, and a flange extending from said wall at an edge of said wall opposite to where the wall extends from the base.

5. The method according to claim 4, wherein a strengthening member is used having
an elongated base,
two longitudinal walls extending from said elongated base at opposite edges of said elongated base,
wherein each longitudinal wall has a flange extending from a respective wall, the flanges extending away from each other.

6. The method according to claim 5, wherein the turbine blade shell has a leading edge and a trailing edge, and the flanges have a flange area facing away from the base, said flange areas being in a plane defined by the leading edge and the trailing edge.

7. The method according to claim 1, wherein the strengthening member is attached to the sealing film with double-sided sealant layer.

8. A turbine blade half manufactured using the method according to claim 1.

9. A method of manufacturing a wind turbine blade, wherein a turbine blade half is obtained by
providing a mold for a turbine blade shell with fiber mats,
placing a strengthening member comprising a base, a wall extending from said base, and a flange extending from said wall at am edge of said wall opposite to where the wall extends from said base over the fiber mats in the mold;
placing an air-impermeable sealing film over the fiber mats and against the strengthening member;
introducing a curable resin in the fiber mats under reduced pressure, including in the area below the strengthening member; and
curing the resin to form a turbine blade half, said turbine blade half comprising a turbine blade shell attached to the strengthening member by the cured resin
and having a leading edge and a trailing edge is connected to a second turbine blade half such that the leading edges of both halves and the trailing edges of said halves are connected and the flange of the strengthening member of the first turbine blade half is connected to the second turbine blade half.

10. The method according to claim 9, wherein each turbine blade half comprises a strengthening member having a flange, and the flanges of opposite turbine blade halves are connected.

11. The method according to claim 9, wherein the halves are connected using a curable resin.

12. A turbine blade manufactured using the method of claim 9.
